(19) United States
(12) Patent Application Publication
(10) Pub. No.: US 2011/0298289 A1
(43) Pub. Date: Dec. 8, 2011

(54) ELECTRONIC APPARATUS WITH PROTECTION CIRCUIT

(75) Inventor: Ing-Ming Lee, Hsinchu (TW)

(73) Assignee: Philips & Lite-on Digital Solutions Corporation, Taipei (TW)

(21) Appl. No.: 12/952,768

(22) Filed: Nov. 23, 2010

(30) Foreign Application Priority Data
Jun. 7, 2010 (CN) 201010199032.0

(51) Int. Cl. H02J 4/00

(52) U.S. Cl. 307/80

(57) ABSTRACT

An electronic apparatus includes a first power source input terminal configured to receive a first driving voltage or a second driving voltage, wherein the second driving voltage is greater than the first driving voltage; a second power source input terminal configured to receive the first driving voltage or the second driving voltage; a protection circuit connected to the first power source input terminal; a first voltage circuit connected to the protection circuit and driven by the first driving voltage; and a second voltage circuit connected to the second power source input terminal and driven by the second driving voltage; wherein the second driving voltage is blocked by the protection circuit and not further transmitted to the first voltage circuit while the second driving voltage is inputted to the first power source input terminal.

This application claims the benefit of People's Republic of China application Serial No. 201010199032.0, filed Jun. 7, 2010, the subject matter of which is incorporated herein by reference.

### FIELD OF THE INVENTION

The present invention relates to an electronic apparatus, and more particularly to an electronic apparatus with a protection circuit for protecting the electronic apparatus while two driving voltages are inputted reversely.

### BACKGROUND OF THE INVENTION

Most electronic apparatuses are operated under a single driving voltage. However, some electronic apparatuses, such as a half-high optical disc drive must be operated under more than one driving voltages. FIG. 1 is a block diagram depicting a conventional optical disc drive system. The optical disc drive system 10 includes a first voltage circuit 12 and a second voltage circuit 14. The first voltage circuit 12 is driven by a first driving voltage which is inputted to a first power source input terminal (V1) of the optical disc drive system 10 from a power connector (not shown); and the second voltage circuit 14 is driven by a second driving voltage which is inputted to a second power source input terminal (V2) of the optical disc drive system 10 from the power connector (not shown). The first voltage circuit 12 includes a plurality of digital circuit (not shown) and the second voltage circuit 14 at least includes a motor drive circuit (not shown). In the optical disc drive system 10, the first driving voltage is about 5V and the second driving voltage is about 12V.

Generally, the plug of the power input terminal and the socket of the power connector have a mistake-proof design in the modern optical disc drive system 10, that is, the first driving voltage and the second driving voltage are always inputted to the optical disc drive system 10 via the first power source input terminal (V1) and the second power source input terminal (V2), respectively. However, if a user is curious or a tester of the optical disc drive system 10 is careless, mistakenly inputting the second driving voltage to the first power source input terminal (V1) and inputting the first driving voltage to the second power source input terminal (V2) may happen.

Once the two driving voltages are inputted to the optical disc drive system 10 reversely, that is the first driving voltage is inputted to the second power source input terminal (V2) and the second driving voltage is inputted to the first power source input terminal (V1), the first driving voltage is then transmitted to the second voltage circuit 14 and the second driving voltage is then transmitted to the first voltage circuit 12. Because the first driving voltage is lower than the second driving voltage, the first driving voltage may not successfully drive the second voltage circuit 14. It is understood that even the second voltage circuit 14 cannot be successfully driven by the first driving voltage, there is no any damage to the second voltage circuit 14 due to the first driving voltage is relatively low. However, because the second driving voltage is relatively high, the second driving may damage the first voltage circuit 12 while the second driving voltage is transmitted to the first voltage circuit 12.

### SUMMARY OF THE INVENTION

Therefore, the present invention relates to an electronic apparatus with a protection circuit for protecting the electronic apparatus while two driving voltages are applied reversely.

The invention provides an electronic apparatus includes a first power source input terminal configured to receive a first driving voltage or a second driving voltage, wherein the second driving voltage is greater than the first driving voltage; a second power source input terminal configured to receive the first driving voltage or the second driving voltage; a protection circuit connected to the first power source input terminal; a first voltage circuit connected to the protection circuit and driven by the first driving voltage; and a second voltage circuit connected to the second power source input terminal and driven by the second driving voltage; wherein the first driving voltage is transmitted to the first voltage circuit through the protection circuit while the first driving voltage is inputted to the first power source input terminal; the second driving voltage is blocked by the protection circuit and not further transmitted to the first voltage circuit while the second driving voltage is inputted to the first power source input terminal.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a block diagram illustrating a conventional optical disc drive system;

FIG. 2 is a block diagram illustrating an optical disc drive system with a protection circuit in a first embodiment of the present invention;

FIG. 3A is a circuit diagram of the protection circuit adopted in the optical disc drive system in the first embodiment;

FIG. 3B is a circuit diagram of the optical disc drive system operated in a normal situation in the first embodiment;

FIG. 3C is a circuit diagram of the optical disc drive system operated in a situation of two driving voltages inputted reversely in the first embodiment;

FIG. 4 is a block diagram of an optical disc drive system with a protection circuit in a second embodiment; and

FIG. 5 is a circuit diagram of the protection circuit adopted in the optical disc drive system in the second embodiment.

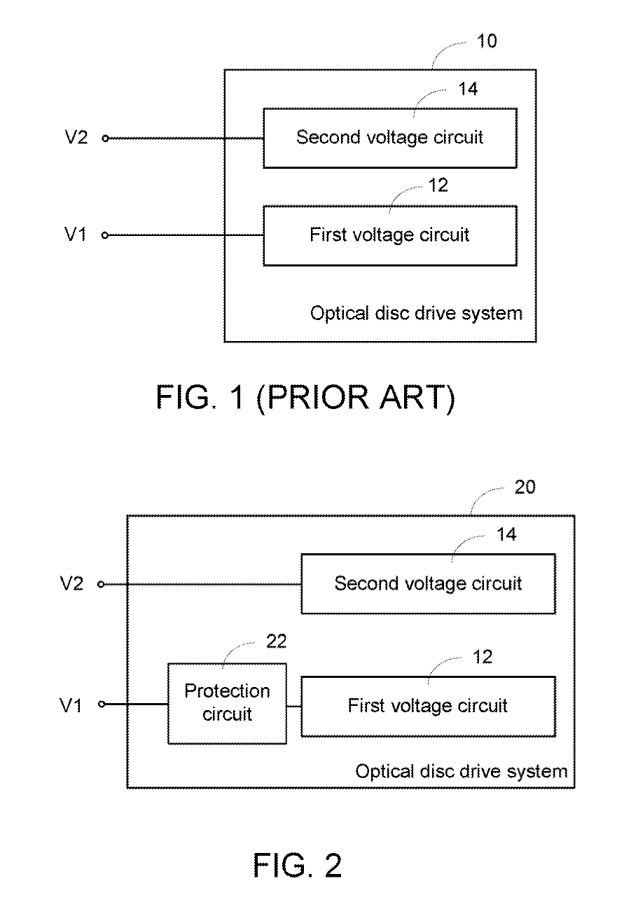

### DETAILED DESCRIPTION OF THE PREFERRED EMBODIMENT

The present invention is an electronic apparatus with a protection circuit for protecting the electronic apparatus while multiple driving voltages are inputted reversely. An optical disc drive system, which is operated under two driving voltages, is used as an example in the electronic apparatus disclosed in the embodiment of the present invention.

FIG. 2 is a block diagram of an optical disc drive system with a protection circuit in a first embodiment of the present invention. The optical disc drive system 20 includes the first voltage circuit 12, the second voltage circuit 14, and a protection circuit 22. The second voltage circuit 14 is connected to the second power source input terminal (V2). The protection circuit 22 is connected between the first power source input terminal (V1) and the first voltage circuit 12. The first voltage circuit 12 includes a plurality of digital circuit (not shown) and the second voltage circuit 14 includes a motor drive circuit (not shown). The first voltage circuit 12 is driven by a first driving voltage (Vd1) and the second voltage circuit 14 is driven by a second driving voltage (Vd2). In the first embodiment, the first driving voltage (Vd1) is about 5V and the second driving voltage (Vd2) is about 12V.

In a normal operation situation, the first driving voltage (Vd1), for driving the first voltage circuit 12, is inputted to the first power source input terminal (V1) from a power connector (not shown) and then further transmitted to the first voltage circuit 12 through the protection circuit 22; and the second driving voltage (Vd2), for driving the second voltage circuit 14, is inputted to the second power source input terminal (V2) from the power connector (not shown) and then directly transmitted to the second voltage circuit 14. However, if the first driving voltage (Vd1) and the second driving voltage (Vd2) are reversely inputted to the optical disc drive system 20, that is the first driving voltage (Vd1) is inputted to the second power source input terminal (V2) and the second driving voltage (Vd2) is inputted to the first power source input terminal (V1), the second driving voltage (Vd2) is then blocked by the protection circuit 22 and not further transmitted to the first voltage circuit 12, accordingly the protection of the first voltage circuit 12 is achieved.

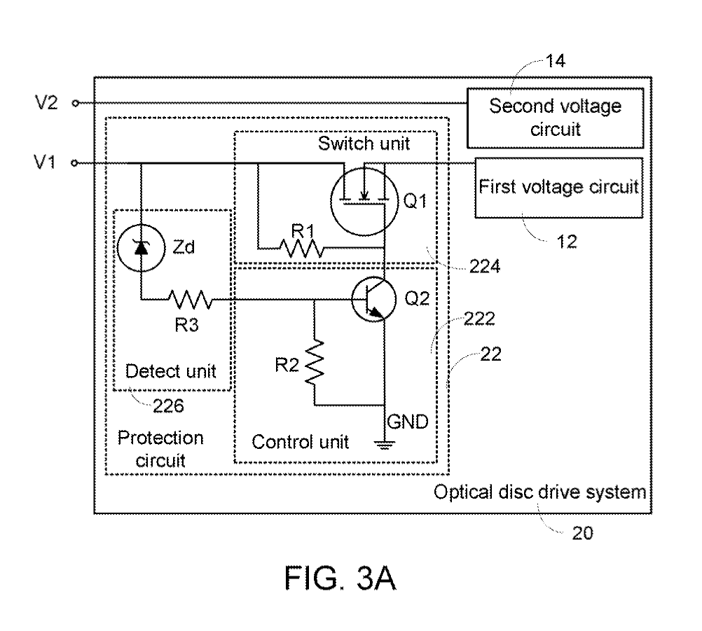

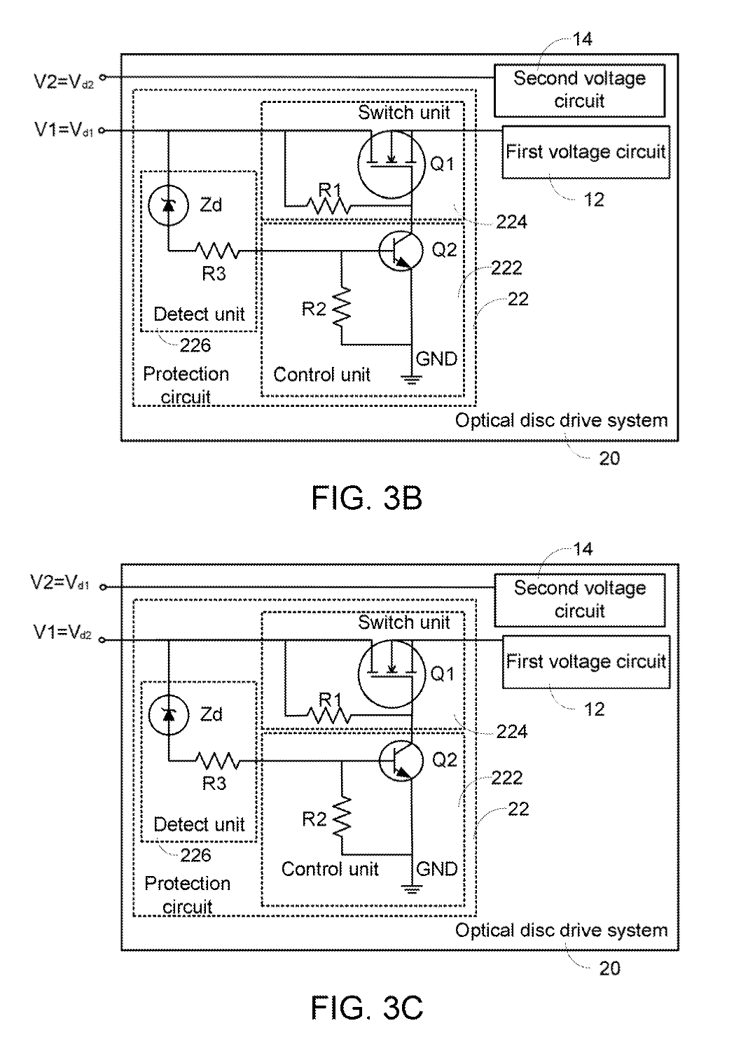

FIG. 3A is a circuit diagram of the protection circuit 22 adopted in the optical disc drive system 20 in the first embodiment of the present invention. The protection circuit 22 includes a detect unit 226, a control unit 222, and a switch unit 224. The detect unit 226 is connected to the first power source input terminal (V1) and the control unit 222. The switch unit 224 is connected to the first power source input terminal (V1), the first voltage circuit 12, and the control unit 222.

In the first embodiment, the detect unit 226 is configured to detect the voltage level appeared at the first power source input terminal (V1), and then enables/or disables the control unit 222 according to the detected voltage level. If the voltage level inputted to the first power source input terminal (V1) is greater than a preset voltage, the detect unit 226 then enables the control unit 222 so as the switch unit 224 is configured to an open circuit, accordingly the relatively high voltage appeared at the first power source input terminal (V1) is blocked by the switch unit 224 and not further transmitted to the first voltage circuit 12. Alternatively, if the voltage level inputted to the first power source input terminal (V1) is less than the preset voltage, the detect unit 226 then disables the control unit 222 so as the switch unit 224 is configured to a close circuit, accordingly the proper voltage appeared at the first power source input terminal (V1) is further transmitted to the first voltage circuit 12.

As depicted in FIG. 3A, the switch unit 224 includes a first transistor (Q1) and a first resistor (R1). The first transistor (Q1) is a NMOS. The drain terminal of the first transistor (Q1) is connected to the first power source input terminal (V1) and the source terminal of the first transistor (Q1) is connected to the first voltage circuit 12. The first resistor (R1) is connected between the gate and drain terminals of the first transistor (Q1).

As depicted in FIG. 3A, the control unit 222 includes a second transistor (Q2) and a second resistor (R2). The second transistor (Q2) is a NPN-BJT. The collector terminal of the second transistor (Q2) is connected to the gate terminal of the first transistor (Q1) and the emitter terminal of the second transistor (Q2) is connected to ground (GND). The second resistor (R2) is connected between the base and emitter terminals of the second transistor (Q2).

As depicted in FIG. 3A, the detect unit 226 includes a zener diode (ZD) and a third resistor (R3). The cathode terminal of the zener diode (ZD) is connected to the first power source input terminal (V1) and the anode terminal is coupled to the base terminal of the second transistor (Q2) via the third resistor (R3).

Moreover, the breakdown voltage (Vzk) of the zener diode (ZD) in the first embodiment is greater than the first driving voltage (Vd1) but less than the second driving voltage (Vd2). For example, the breakdown voltage (Vzk) of the zener diode (ZD) is assigned to 5.1V if the first driving voltage (Vd1) is 5V and the second driving voltage (Vd2) is 12V in the optical disc drive system 20. Moreover, the preset voltage is equal to the breakdown voltage (Vzk) of the zener diode (ZD) in the first embodiment.

Following is the detail description of the function of the protection circuit 22 while the optical disc drive system 20 is operated in a normal situation or in a situation of two driving voltages inputted reversely. FIG. 3B is a circuit diagram of the optical disc drive system 20 operated in a normal situation in the first embodiment. In the normal situation, the first driving voltage (Vd1) is inputted to the first power source input terminal (V1) and the second driving voltage (Vd2) is inputted to the second power source input terminal (V2) from a power connector (not shown). Because the first driving voltage (Vd1) (the voltage level appeared at the first power source input terminal (V1)) is lower than the breakdown voltage (Vzk) of the zener diode (ZD) (or preset voltage), the zener diode (ZD) is configured to an open circuit. Moreover, because the base and emitter terminals of the second transistor (Q2) are connected to ground (GND), the second transistor (Q2) is configured to an open circuit. Moreover, because the second transistor (Q2) is configured to an open circuit, the first driving voltage (Vd1) appeared at the first power source input terminal (V1) is transmitted to the gate terminal of the first transistor (Q1) so as the first transistor (Q1) is configured to a close circuit. Moreover, because the first transistor (Q1) is configured to a close circuit, the first driving voltage (Vd1) appeared at the first power source input terminal (V1) is transmitted to first voltage circuit 12 via the first transistor (Q1) which is configured to a close circuit. Moreover, the second driving voltage (Vd2) inputted to the second power source input terminal (V2) from a power connector (not shown) is directly transmitted to the second voltage circuit 14, as depicted in FIG. 3B.

Therefore, the first driving voltage (Vd1) outputted from a power connector (not shown) is transmitted to the first voltage circuit 12 via the protection circuit 22 and the second driving voltage (Vd2) outputted from a power connector (not shown) is directly transmitted to the second voltage circuit 14 while the optical disc drive system 20 is operated in the normal situation in the first embodiment.

FIG. 3C is a circuit diagram of the optical disc drive system 20 operated in a situation of two driving voltages inputted reversely in the first embodiment. In the situation of the two driving voltages are inputted reversely, the first driving voltage (Vd1) is inputted to the second power source input terminal (V2) and the second driving voltage (Vd2) is inputted to the first power source input terminal (V1) from a power connector (not shown). Because the second driving voltage (Vd2) (the voltage level appeared at the first power source input terminal (V1)) is higher than the breakdown voltage (Vzk) of the zener diode (ZD) (or preset voltage), the zener diode (ZD) is configured to a close circuit. Moreover, because the zener diode (ZD) is configured to a close circuit, a specific voltage is appeared at the base terminal of the second transistor (Q2) so as the second transistor (Q2) is configured to a close circuit. Moreover, because the second transistor (Q2) is configured to a close circuit, the gate terminal of the first transistor (Q1) is connected to ground (GND) so as the first transistor (Q1) is configured to an open circuit, accordingly the second driving voltage (Vd2) appeared at the first power source input terminal (V1) is blocked by the first transistor (Q1) and cannot be further transmitted to the first voltage circuit 12. Because the second driving voltage (Vd2) is blocked by the protection circuit 22 and not transmitted to the first voltage circuit 12 while the second driving voltage (Vd2) is mistakenly inputted to the first power source input terminal (V1), the risk of damaging the first voltage circuit 12 resulted by the relatively high second driving voltage (Vd2) is avoided so as the protection of the first voltage circuit 12 is achieved. Moreover, the first driving voltage (Vd1) which is inputted to the second power source input terminal (V2) is directly transmitted to the second voltage circuit 14, as depicted in FIG. 3C.

Therefore, while the two driving voltages are reversely inputted to the optical disc drive system 20 in the first embodiment (that is, the first driving voltage (Vd1) is inputted to the second power source input terminal (V2) and the second driving voltage (Vd2) is inputted to the first power source input terminal (V1)), the second driving voltage (Vd2) is blocked by the protection circuit 22 and not further transmitted to the first voltage circuit 12 so as the protection of the first voltage circuit 12 is achieved. Moreover, because the first driving voltage (Vd1) is relatively low, no any damage is done to the second voltage circuit 14 while the first driving voltage (Vd1) is mistakenly inputted to the second power source input terminal (V2).

Moreover, while a user is aware of the optical disc drive system 20 cannot function normally due to the two driving voltages are inputted reversely, the optical disc drive system 20 still can back to its normal function if the user reverses the two driving voltages again.

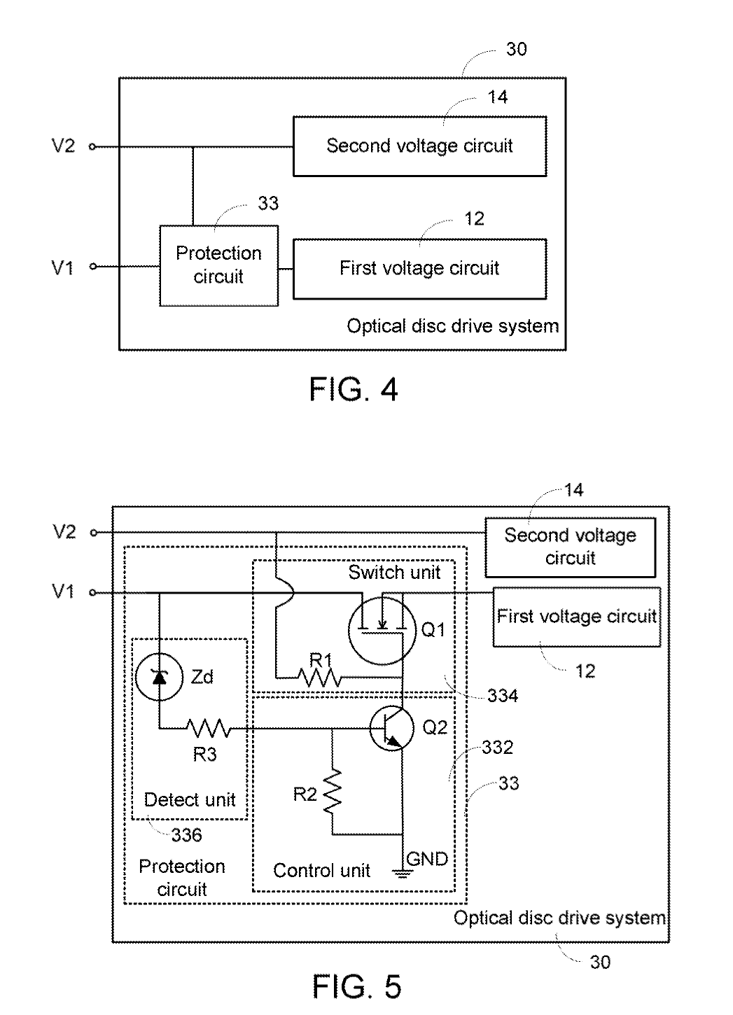

FIG. 4 is a block diagram of an optical disc drive system with a protection circuit in a second embodiment of the present invention. The optical disc drive system 30 in the second embodiment includes the first voltage circuit 12, the second voltage circuit 14, and a protection circuit 33. The protection circuit 33 is connected to the first power source input terminal (V1), the second power source input terminal (V2), and the first voltage circuit 12.

In a normal operation situation, the first driving voltage (Vd1) is inputted to the first power source input terminal (V1) from an power connector (not shown) and then further transmitted to the first voltage circuit 12 through the protection circuit 33; and the second driving voltage (Vd2) is inputted to the second power source input terminal (V2) from the power connector (not shown) and then directly transmitted to the second voltage circuit 14. However, if the first driving voltage (Vd1) and the second driving voltage (Vd2) are reversely inputted to the optical disc drive system 30, that is the first driving voltage (Vd1) is inputted to the second power source input terminal (V2) and the second driving voltage (Vd2) is inputted to the first power source input terminal (V1), the second driving voltage (Vd2) is then blocked by the protection circuit 33 and not further transmitted to the first voltage circuit 12, accordingly the circuit protection of the first voltage circuit 12 is achieved.

FIG. 5 is a circuit diagram of the protection circuit 33 adopted in the optical disc drive system 30 in the second embodiment. The protection circuit 33 includes a detect unit 336, a control unit 332, and a switch unit 334. Compared with the protection circuit 22 in the first embodiment depicted in FIG. 3A, the switch unit 334 is also coupled to the second power source input terminal (V2). Moreover, the first resistor (R1) is connected between the second power source input terminal (V2) and the gate terminal of the first transistor (Q1).

While the optical disc drive system 30 is operated in the normal situation, that is the first driving voltage (Vd1) is inputted to the first power source input terminal (V1) and the second driving voltage (Vd2) is inputted to the second power source input terminal (V2) from a power connector (not shown), the zener diode (ZD) is configured to an open circuit; the second transistor (Q2) is configured to an open circuit; and the first transistor (Q1) is configured to a close circuit. Except the first transistor (Q1) is configured to a close circuit through the second driving voltage (Vd2) which is inputted to the gate terminal of the first transistor (Q1) from the second power source input terminal (V2), the function of the protection circuit 33 in the second embodiment is similar to the function of the protection circuit 22 in the first embodiment while the optical disc drive system 30 is operated in a normal situation, no unnecessary detail is given here. Because the first transistor (Q1) is configured to a close circuit, the first driving voltage (Vd1) appeared at the first power source input terminal (V1) is transmitted to first voltage circuit 12 via the first transistor (Q1) which is configured to a close circuit. Moreover, as depicted in FIG. 5, the second driving voltage (Vd2) inputted to the second power source input terminal (V2) from a power connector (not shown) is directly transmitted to the second voltage circuit 14.

While the optical disc drive system 30 is operated in a situation of the two driving voltages are inputted reversely, that is the first driving voltage (Vd1) is inputted to the second power source input terminal (V2) and the second driving voltage (Vd2) is inputted to the first power source input terminal (V1) from a power connector (not shown), the zener diode (ZD) is configured to a close circuit; the second transistor (Q2) is configured to a close circuit; and the first transistor (Q1) is configured to an open circuit. Because the function of the protection circuit 33 in the second embodiment is similar to the function of the protection circuit 22 in the first embodiment while the optical disc drive system 30 is operated in a situation of two driving voltages are reversely inputted, no unnecessary detail is given here. Because the first transistor (Q1) is configured to an open circuit, the second driving voltage (Vd2) appeared at the first power source input terminal (V1) is blocked and not further transmitted to the first voltage circuit 12. Because the second driving voltage (Vd2) is blocked by the protection circuit 22 and not transmitted to the first voltage circuit 12 while the second driving voltage (Vd2) is mistakenly inputted to the first power source input terminal (V1), the risk of damaging the first voltage circuit 12 resulted by the relatively high second driving voltage (Vd2) is avoided so as the protection of the first voltage circuit 12 is achieved. Moreover, the first driving voltage (Vd1) inputted to the second power source input terminal (V2) is directly transmitted to the second voltage circuit 14, as depicted in FIG. 5.

Therefore, while the two driving voltages are reversely inputted to the optical disc drive system 30 in the second embodiment (that is, the first driving voltage (Vd1) is inputted to the second power source input terminal (V2) and the second driving voltage (Vd2) is inputted to the first power source input terminal (V1)), the second driving voltage (Vd2) is blocked by the protection circuit 33 and not further transmitted to the first voltage circuit 12 so as the protection of the first voltage circuit 12 is achieved. Moreover, because the first driving voltage (Vd1) is relatively low, no any damage is done to the second voltage circuit 14 while the first driving voltage (Vd1) is mistakenly inputted to the second power source input terminal (V2).

Moreover, while a user is aware of the optical disc drive system 30 cannot function normally due to the two driving voltages are inputted reversely, the optical disc drive system 30 can back to its normal function if the user reverses the two driving voltages again.

Moreover, it is understood that the protection circuit 22 and 33 in the present invention is not limited to apply to an optical disc drive system. The protection circuit 22 and 33 in the present invention can be also applied to other electronic apparatuses such as a hard drive disc system which needs more than one driving voltages.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic apparatus comprising:
a first power source input terminal configured to receive a first driving voltage or a second driving voltage, wherein the second driving voltage is greater than the first driving voltage;
a second power source input terminal configured to receive the first driving voltage or the second driving voltage;
a protection circuit connected to the first power source input terminal;
a first voltage circuit connected to the protection circuit and driven by the first driving voltage; and
a second voltage circuit connected to the second power source input terminal and driven by the second driving voltage;
wherein the first driving voltage is transmitted to the first voltage circuit through the protection circuit while the first driving voltage is inputted to the first power source input terminal; the second driving voltage is blocked by the protection circuit and not further transmitted to the first voltage circuit while the second driving voltage is inputted to the first power source input terminal.

2. The electronic apparatus according to claim 1 wherein the first driving voltage is 5 volt and the second driving voltage is 12 volt.

3. The electronic apparatus according to claim 1 wherein the electronic apparatus is an optical disc drive system or a hard disc drive system.

4. The electronic apparatus according to claim 1 wherein the first voltage circuit comprises a digital circuit and the second voltage circuit comprises a motor drive circuit.

5. The electronic apparatus according to claim 1 wherein the protection circuit comprises:
a switch unit connected to the first power source input terminal and the first voltage circuit;
a detect unit connected to the first power source input terminal and configured to detect an input voltage appeared at the first power source input terminal; and
a control unit connected between the switch unit and the detect unit;
wherein while the input voltage is greater than a preset voltage, the control unit is enabled by the detect unit, and the switch unit is configured to an open circuit so as the input voltage is blocked and not transmitted to the first voltage circuit; while the input voltage is less than the preset voltage, the control unit is disabled by the detect unit, and the switch unit is configured to a close circuit so as the input voltage is further transmitted to the first voltage circuit.

6. The electronic apparatus according to claim 5 wherein the switch unit comprises:
a first transistor, wherein the drain terminal of the first transistor is connected to the first power source input terminal and the source terminal of the first transistor is connected to the first voltage circuit; and
a first resistor connected between the gate terminal and the drain terminal of the first transistor.

7. The electronic apparatus according to claim 6 wherein the first transistor is a NMOS.

8. The electronic apparatus according to claim 6 wherein the control unit comprises:
a second transistor, wherein the collector terminal of the second transistor is connected to the gate terminal of the first transistor in the switch unit and the emitter terminal of the second transistor is connected to ground; and
a second resistor connected between the base terminal and the emitter terminal of the second transistor.

9. The electronic apparatus according to claim 8 wherein the second transistor is a NPN-BJT.

10. The electronic apparatus according to claim 8 wherein the detect unit comprises:
a zener diode, wherein the cathode terminal of the zener diode is connected to the first power source input terminal; and
a third resistor connected between the anode terminal of the zener diode and the base terminal of the second transistor in the control unit.

11. The electronic apparatus according to claim 10 wherein the value of a breakdown voltage of the zener diode is equal to the value of the preset voltage, and the value of the breakdown voltage is greater than the first driving voltage but less than the second driving voltage.

12. The electronic apparatus according to claim 1 wherein the protection circuit is further connected to the second power source input terminal, the first driving voltage is transmitted to the first voltage circuit through the protection circuit while the first driving voltage is inputted to the first power source input terminal and the second driving voltage is inputted to the second power source input terminal; the second driving voltage is blocked by the protection circuit and not further transmitted to the first voltage circuit while the second driving voltage is inputted to the first power source input terminal.

13. The electronic apparatus according to claim 12 wherein the protection circuit comprises:
a switch unit connected to the first power source input terminal and the first voltage circuit;
a detect unit connected to the first power source input terminal and configured to detect an input voltage appeared at the first power source input terminal; and
a control unit connected between the switch unit and the detect unit;
wherein while the input voltage is greater than a preset voltage, the control unit is enabled by the detect unit, and the switch unit is configured to an open circuit so as the input voltage is blocked and not transmitted to the first voltage circuit; while the input voltage is less than the preset voltage, the control unit is disabled by the detect unit, and the switch unit is configured to a close circuit so as the input voltage is further transmitted to the first voltage circuit.

14. The electronic apparatus according to claim 13 wherein the switch unit comprises:
a first transistor, wherein the drain terminal of the first transistor is connected to the first power source input terminal and the source terminal of the first transistor is connected to the first voltage circuit; and
a first resistor connected between the second power source input terminal and the gate terminal of the first transistor.

15. The electronic apparatus according to claim 14 wherein the first transistor is a NMOS.

16. The electronic apparatus according to claim 14 wherein the control unit comprises:
a second transistor, wherein the collector terminal of the second transistor is connected to the gate terminal of the first transistor in the switch unit and the emitter terminal of the second transistor is connected to ground; and
a second resistor connected between the base terminal and the emitter terminal of the second transistor.

17. The electronic apparatus according to claim 16 wherein the second transistor is a NPN-BJT.

18. The electronic apparatus according to claim 16 wherein the detect unit comprises:
a zener diode, wherein the cathode terminal of the zener diode is connected to the first power source input terminal; and
a third resistor connected between the anode terminal of the zener diode and the base terminal of the second transistor in the control unit.

19. The electronic apparatus according to claim 18 wherein the value of a breakdown voltage of the zener diode is equal to the value of the preset voltage, and the value of the breakdown voltage is greater than the first driving voltage but less than the second driving voltage.
